(19) United States
(12) Patent Application Publication
(10) Pub. No.: US 2006/0148450 A1
(43) Pub. Date: Jul. 6, 2006

(54) Wireless trust kiosk

(76) Inventor: Victor B. Lortz, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,655

(22) Filed: Dec. 30, 2004

(51) Int. Cl. H04B 1/38; H04M 1/00; H04M 1/66

(52) U.S. Cl. 455/411; 455/410

(57) ABSTRACT

In some embodiments, a wireless trust kiosk is presented. In this regard, a trust agent is introduced to receive an out-of-band communication from a known wireless network provider, to use the communication to challenge the identity of a wireless network, and to connect to the wireless network if it is provided by the known wireless network provider. Other embodiments are also disclosed and claimed.

### FIELD OF THE INVENTION

Embodiments of the present invention generally relate to the field of wireless network security, and, more particularly to a wireless trust kiosk.

### BACKGROUND OF THE INVENTION

Wireless networking offers many new opportunities for location-specific e-commerce. Shoppers with mobile wireless devices such as laptops, PDAs, and cell phones, are an attractive target for retail vendors in venues such as airports, hotels, shopping malls, department stores, and downtown shopping districts. Unfortunately, shoppers in these locations are also an attractive target to thieves. What's more, thieves with inexpensive wireless equipment can pose as legitimate location-specific network operators to steal credit card data and personal data such as financial records and other valuable information at very low risk of detection. The fundamental reasons for this vulnerability are: 1) user clients (browsers) accept network credentials that can be readily obtained by attackers from commercial certificate authorities, and 2) there is no convenient way for a user to determine whether the network or web site they are communicating with is legitimate.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing a trust agent, in accordance with one example embodiment of the invention;

FIG. 2 is a block diagram of an example trust agent architecture, in accordance with one example embodiment of the invention;

FIG. 3 is a flow chart of an example method to develop trust in a wireless network provider, in accordance with one example embodiment of the invention; and

FIG. 4 is a block diagram of an example storage medium comprising content which, when accessed by a device, causes the device to implement one or more aspects of one or more embodiment(s) of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a block diagram of an example electronic appliance suitable for implementing a trust agent, in accordance with one example embodiment of the invention. Electronic appliance 100 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, trust agent 106, system memory 108, input/output controller 110, network controller 112 and input/output device(s) 114 coupled as shown in FIG. 1. Trust agent 106, as described more fully hereinafter, may well be used in electronic appliances of greater or lesser complexity than that depicted in FIG. 1. Also, the innovative attributes of trust agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge.

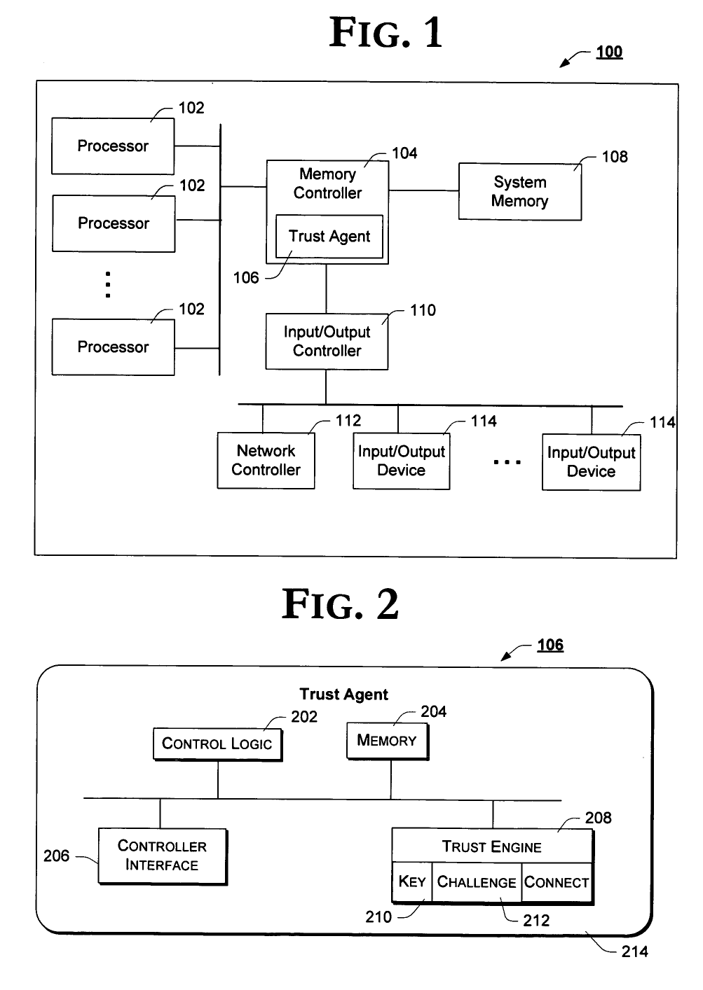

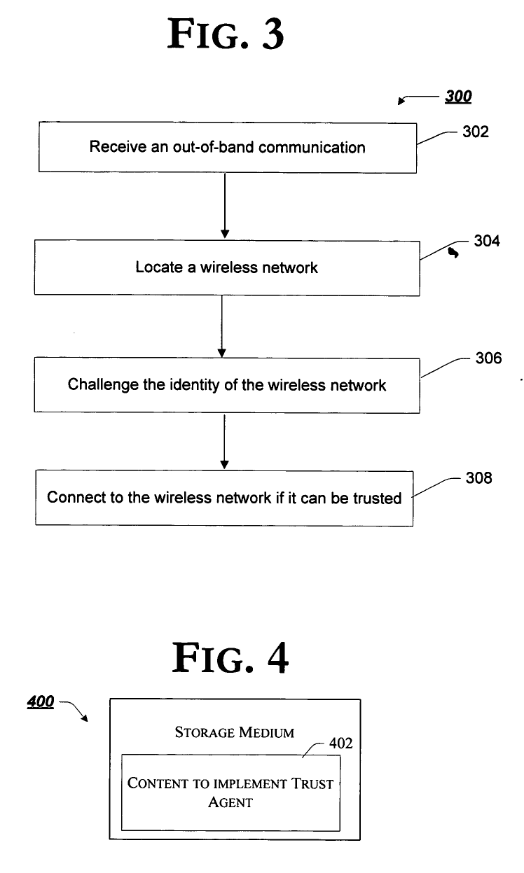

Trust agent 106 may have an architecture as described in greater detail with reference to FIG. 2. Trust agent 106 may also perform one or more methods to develop trust in a wireless network provider, such as the method described in greater detail with reference to FIG. 3. While shown as being part of memory controller 104, trust agent 106 may well be part of another component, for example processor(s) 102 or network controller 112, or may be implemented in software or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM). The present invention, however, is not limited to the examples of memory mentioned here.

Input/output (I/O) controller 110 may represent any type of chipset or control logic that interfaces I/O device(s) 112 with the other components of electronic appliance 100. In one embodiment, I/O controller 110 may be referred to as a south bridge. In another embodiment, I/O controller 110 may comply with the Peripheral Component Interconnect (PCI) Express™ Base Specification, Revision 1.0a, PCI Special Interest Group, released Apr. 15, 2003. I/O controller 110 may have internal status registers relating to its operation and the operation of I/O device(s) 112.

Network controller 112 may represent any type of controller that electronic appliance 100 to communicate with other network devices, including other electronic appliances and access points. In one embodiment, though the present invention is not so limited, network controller 112 may comply with a The Institute of Electrical and Electronics Engineers, Inc. (IEEE) 802.11b standard (approved Sep. 16, 1999, supplement to ANSI/IEEE Std 802.11, 1999 Edition).

Input/output (I/O) device(s) 114 may represent any type of device, peripheral or component that provides input to or processes output from electronic appliance 100. In one embodiment, at least one I/O device 114 may be an infrared (IR), radio frequency identification (RFID), smart card, or Universal Serial Bus (USB) interface controllers.

FIG. 2 is a block diagram of an example trust agent architecture, in accordance with one example embodiment of the invention. As shown, trust agent 106 may include one or more of control logic 202, memory 204, controller interface 206, and trust engine 208 coupled as shown in FIG. 2. In accordance with one aspect of the present invention, to be developed more fully below, trust agent 106 may include a trust engine 208 comprising one or more of key services 210, challenge services 212, and/or connect services 214. It is to be appreciated that, although depicted as a number of disparate functional blocks, one or more of elements 202-214 may well be combined into one or more multi-functional blocks. Similarly, trust engine 208 may well be practiced with fewer functional blocks, i.e., with only challenge services 212, without deviating from the spirit and scope of the present invention, and may well be implemented in hardware, software, firmware, or any combination thereof. In this regard, trust agent 106 in general, and trust engine 208 in particular, are merely illustrative of one example implementation of one aspect of the present invention. As used herein, trust agent 106 may well be embodied in hardware, software, firmware and/or any combination thereof.

Trust agent 106 may have the ability to receive an out-of-band communication at a kiosk from a known wireless network provider, to use the communication to challenge the identity of a wireless network, and to connect to the wireless network if it is provided by the known wireless network provider. By “out-of-band”, we mean a communication channel other than the wireless network that is inherently resistant to man-in-the-middle attack and may also be resistant to eavesdropping attack. The out-of-band channel also includes the property of “locality” to provide the user with an accurate and intuitive understanding of the physical device with which the out-of-band communication is taking place. In one embodiment, the kiosk could be a station (manned or not) that is clearly associated with the operator of the venue. The kiosk could include the functionality of a wireless network access point. In another embodiment, the kiosk promotes the wireless network being provided without being an access point of the wireless network.

As used herein control logic 202 provides the logical interface between trust agent 106 and its host electronic appliance 100. In this regard, control logic 202 may manage one or more aspects of trust agent 106 to provide a communication interface to electronic appliance 100, e.g., through memory controller 104.

According to one aspect of the present invention, though the claims are not so limited, control logic 202 may selectively invoke the resource(s) of trust engine 208. As part of an example method to develop trust in a wireless network provider, as explained in greater detail with reference to FIG. 3, control logic 202 may selectively invoke key services 210 that may store a key and/or other information received from the wireless network provider out-of-band. Control logic 202 also may selectively invoke challenge services 212 or connect services 214, as explained in greater detail with reference to FIG. 3, to challenge the identity of a wireless network or to connect to a trusted network, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store cryptographic keys, passwords, certificates, shared secrets, and/or identification information from a wireless network provider, for example.

Controller interface 206 provides a path through which trust agent 106 can communicate with memory controller 104. In one embodiment, controller interface 206 may represent any of a wide variety of interfaces or controllers known in the art. In another embodiment, controller interface 206 may comply with the System Management Bus (SMBus) Specification, Version 2.0, SBS Implementers Forum, released Aug. 3, 2000.

Key services 210, as introduced above, may provide trust agent 106 with the ability to store a key and/or other information received from the wireless network provider out-of-band. In one example embodiment, key services 210 may receive a key and other network provider information at a kiosk through an out-of-band channel, such as a channel provided by I/O device(s) 114. Examples of such channels include USB, smart card, RFID, IR, or any other channel for receiving communication other than the channel used by network controller 112. The key can include a public cryptographic key or a shared secret. Other information, such as a service set identifier, may also be conveyed by the wireless network provider. Key services 210 may store the key and other network provider information in memory 204 for future use.

As introduced above, challenge services 212 may provide trust agent 106 with the ability to challenge the identity of a wireless network. In one example embodiment, challenge services 212 may block connection to a wireless network located by network controller 112 until the wireless network provides a communication that indicates the wireless network operator knows the key obtained on the out-of-band channel. Challenge services 212 may authenticate communications from a wireless network using a public key stored in memory 204, and if the authentication operation succeeds, challenge services 212 may trust the wireless network so as to allow network controller 112 to establish a connection.

Connect services 214, as introduced above, may provide trust agent 106 with the ability to connect to a trusted network. In one embodiment, connect services 214 may locate wireless networks transmitting in an area, but will not establish a connection until allowed by challenge services 212.

FIG. 3 is a flow chart of an example method to develop trust in a wireless network provider, in accordance with one example embodiment of the invention. It will be readily apparent to those of ordinary skill in the art that although the following operations may be described as a sequential process, some of the operations may in fact be performed in parallel or concurrently. In addition, the order of some operations may be re-arranged without departing from the spirit of embodiments of the invention.

According to one example implementation, method 300 begins with key services 210 being invoked to receive (302) an out-of-band communication. In one example embodiment, key services 210 receives the communication through a channel provided by one of I/O device(s) 114. Key services 210 may store and catalog the information received in a table in memory 204 for future use.

Next, network controller 112 may locate (304) a wireless network. In one example embodiment, connect services 214 locate an access point transmitting over the wireless network channel, but do not establish a complete connection with the access point yet.

Next, challenge services 212 may challenge (306) the identity of the wireless network. In one embodiment, challenge services 212 requires the network to prove possession of the key(s) conveyed across the out-of-band channel and stored in memory 204. If the network does not have matching credentials, challenge services 212 will prevent electronic appliance 100 from connecting the network.

Next, control logic 202 may selectively invoke connect services 214 to connect (308) to the wireless network if it can be trusted. In one example embodiment, connect services 214 establishes a connection as provided in the 802.11b standard.

FIG. 4 illustrates a block diagram of an example storage medium comprising content which, when accessed by a device, causes the device to implement one or more embodiment(s) of the invention, for example trust agent 106 and/or associated method 300. In this regard, storage medium 400 includes content 402 (e.g., instructions, data, or any combination thereof) which, when executed, causes the appliance to implement one or more aspects of trust agent 106, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
receiving an out-of-band communication from a known wireless network provider;
using the communication to challenge the identity of a wireless network; and
connecting to the wireless network if it is provided by the known wireless network provider.

2. The method of claim 1, further comprising:
receiving the out-of-band communication at a kiosk that is not a wireless network access point.

3. The method of claim 1, wherein receiving an out-of-band communication comprises:
receiving a communication selected from the group consisting of a service set identifier (ssid), a shared secret, certificate, and a public key.

4. The method of claim 1, further comprising:
storing the communication for future use.

5. The method of claim 1, wherein receiving an out-of-band communication comprises:
receiving a communication from an interface selected from the group consisting of Universal Serial Bus (USB), infrared (IR), smart card, and radio frequency identification (RFID).

6. The method of claim 1, wherein using the communication to challenge the identity of a wireless network comprises:
determining if a response from a wireless network would indicate the wireless network is provided by the known wireless network provider.

7. An electronic appliance, comprising:
a processor;
a wireless network interface controller; and
a trust engine coupled with the processor and the wireless network interface controller, the trust engine to receive an out-of-band communication at a kiosk from a known wireless network provider, to use the communication to challenge the identity of a wireless network, and to connect to the wireless network if it is provided by the known wireless network provider.

8. The electronic appliance of claim 7, further comprising:
the trust engine to authenticate communications from the wireless network.

9. The electronic appliance of claim 7, wherein the out-of-band communication comprises:
a communication from an interface selected from the group consisting of Universal Serial Bus (USB), infrared (IR), smart card, and radio frequency identification (RFID).

10. The electronic appliance of claim 7, wherein the out-of-band communication comprises:
a communication selected from the group consisting of a service set identifier (ssid), a shared secret, certificate, and a public key.

11. A storage medium comprising content which, when executed by an accessing machine, causes the accessing machine to receive an out-of-band communication at a kiosk from a known wireless network provider, to use the communication to challenge the identity of a wireless network, and to connect to the wireless network if it is provided by the known wireless network provider.

12. The storage medium of claim 11, further comprising content which, when executed by the accessing machine, causes the accessing machine to authenticate communications from the wireless network.

13. The storage medium of claim 11, wherein the content to receive an out-of-band communication comprises content which, when executed by the accessing machine, causes the accessing machine to receive a communication from an interface selected from the group consisting of Universal Serial Bus (USB), infrared (IR), smart card, and radio frequency identification (RFID).

14. The storage medium of claim 11, wherein the content to receive an out-of-band communication comprises content which, when executed by the accessing machine, causes the accessing machine to receive a communication selected from the group consisting of a service set identifier (ssid), a shared secret, certificate, and a public key.

15. The storage medium of claim 11, wherein the content to use the communication to challenge the identity of a wireless network comprises content which, when executed by the accessing machine, causes the accessing machine to determine if a response from a wireless network would indicate the wireless network is provided by the known wireless network provider.

16. An apparatus, comprising:
a network interface;
a memory; and
control logic coupled with the memory and network interface, the control logic to receive an out-of-band communication at a kiosk from a known wireless network provider, to use the communication to challenge the identity of a wireless network, and to connect to the wireless network if it is provided by the known wireless network provider.

17. The apparatus of claim 16, further comprising control logic to authenticate communications from the wireless network.

18. The apparatus of claim 17, wherein the control logic to receive an out-of-band communication comprises control logic to receive a communication from an interface selected from the group consisting of Universal Serial Bus (USB), infrared (IR), smart card, and radio frequency identification (RFID).

19. The apparatus of claim 18, wherein the control logic to receive an out-of-band communication comprises control logic to receive a communication selected from the group consisting of a service set identifier (ssid), a shared secret, certificate, and a public key.

20. The apparatus of claim 19, wherein the control logic to use the communication to challenge the identity of a wireless network comprises control logic to determine if a response from a wireless network would indicate the wireless network is provided by the known wireless network provider.
